(19) United States
(12) Patent Application Publication
(10) Pub. No.: US 2026/0220442 A1
(43) Pub. Date: Jul. 30, 2026

(54) DATA PROCESSING DEVICE, DATA PROCESSING METHOD, AND STORAGE MEDIUM

(71) Applicant: SOFTBANK GROUP CORP., Tokyo (JP)

(72) Inventors: Satoru OOTAGURO, Tokyo (JP); Tetsuya KATOUGI, Tokyo (JP); Asami UCHIYAMA, Tokyo (JP)

(73) Assignee: SOFTBANK GROUP CORP., Tokyo (JP)

(21) Appl. No.: 19/571,256

(22) Filed: Mar. 18, 2026

Related U.S. Application Data
(63) Continuation of application No. 19/455,201, filed on Jan. 21, 2026.

(30) Foreign Application Priority Data
Jan. 24, 2025 (JP) 2025-010741

(51) Int. Cl. G06N 3/0475; G06F 16/3329; G10L 15/26

(52) U.S. Cl. CPC G06N 3/0475; G06F 16/33295; G10L 15/26

(57) ABSTRACT

An example data processing device includes: a memory; and a processor that is configured to: generate a travel plan based on information regarding a user and generative AI trained in advance using information regarding tour guides’ knowledge; and output information regarding the travel plan.

### CROSS-REFERENCE TO RELATED APPLICATION

This application is a continuation application of U.S. Application No. 19/455,201, filed on January 21, 2026, and is based on and claims priority under 35 USC 119 from Japanese Patent Application No. 2025-010741 filed on January 24, 2025, the disclosures of each of these applications is incorporated by reference herein.

### TECHNICAL FIELD

The technology of the present disclosure relates to a data processing device, a data processing method, and a non-transitory storage medium storing a program.

### BACKGROUND

Japanese Patent Application Laid-Open (JP-A) No. 2013-134555 discloses a reservation system that provides a travel product in which an accommodation facility and a transportation means are associated with each other in response to a request from a user terminal, and enables a user to reserve the travel product.

The technology described in JP-A No. 2013-134555 targets only travel products in which accommodation facilities and transportation means are associated with each other, and thus, there is room for improvement from the viewpoint of providing a travel plan with a high degree of freedom suitable for a user.

### SUMMARY

A first aspect of the present disclosure is a data processing device including: a generation unit configured to generate a travel plan based on information regarding a user and generative AI trained in advance using information regarding tour guides’ knowledge; and an output unit configured to output information regarding the travel plan.

A second aspect of the present disclosure is a data processing method executed by a computer, including: generating a travel plan based on information regarding a user and generative AI trained in advance using information regarding tour guides’ knowledge; and outputting information regarding the travel plan.

A third aspect of the present disclosure is a non-transitory storage medium storing a program that causes a computer to execute information processing, the information processing including: generating a travel plan based on information regarding a user and generative AI trained in advance using information regarding tour guides’ knowledge; and outputting information regarding the travel plan.

### BRIEF DESCRIPTION OF THE DRAWINGS

Exemplary embodiments of the present invention will be described in detail based on the following figures, wherein:

FIG. 1 is a block diagram illustrating an example of a configuration of a data processing system;

FIG. 2 is a block diagram illustrating an example of functions of main parts of a data processing device;

FIG. 3 is a diagram for explaining how to train a data generation model;

FIG. 4 is a block diagram illustrating an example of a functional configuration of a first processing unit of the data processing device;

FIG. 5 illustrates an example of a prompt input into a data generation model that generates a travel plan;

FIG. 6 illustrates an example of interactions with a user;

FIG. 7 illustrates an example of a first travel plan;

FIG. 8 illustrates an example of a second travel plan;

FIG. 9 illustrates an example of a highlight of a travel plan;

FIG. 10 illustrates examples of points of ingenuity in a travel plan;

FIG. 11 illustrates an example of alternative store information;

FIG. 12 is a block diagram illustrating an example of a functional configuration of a second processing unit of the data processing device;

FIG. 13 illustrates an example of a guide avatar;

FIG. 14 is a flowchart illustrating an example of travel plan generation processing;

FIG. 15 is a flowchart illustrating an example of avatar generation processing;

FIG. 16 illustrates an example of a prompt;

FIG. 17 illustrates an example of how to explain a sightseeing spot and a related topic; and

FIG. 18 is a flowchart illustrating an example of voice input processing.

### DETAILED DESCRIPTION

Hereinafter, embodiments of a data processing device, a data processing method, and a non-transitory storage medium storing a program according to the technology of the present disclosure will be described with reference to the accompanying drawings.

First, words used in the following description will be described.

In the following embodiments, a processor to which a reference sign (hereinafter, simply referred to as “processor”) may be one arithmetic device or a combination of plural arithmetic devices. In addition, the processor may be one type of arithmetic device or a combination of plural types of arithmetic devices. Examples of the arithmetic device include a central processing unit (CPU), a graphics processing unit (GPU), a general-purpose computing on graphics processing unit (GPGPU), an accelerated processing unit (APU), and the like.

In the following embodiments, a random access memory (RAM) to which a reference sign is attached is a memory in which information is temporarily stored, and is used as a work memory by the processor.

In the following embodiments, a storage to which a reference sign is attached is one or more nonvolatile storage devices that store various programs, various parameters, and the like. Examples of the nonvolatile storage device include a flash memory (e.g. solid state drive (SSD)), a magnetic disk (e.g., a hard disk), and a magnetic tape.

In the following embodiments, a communication interface (I/F) to which a reference sign is attached is an interface including a communication processor, an antenna, etc. The communication I/F manages communication between plural computers. Examples of the communication standard applied to the communication I/F include wireless communication standards including a 5th generation mobile communication system (5G), Wi-Fi®, and Bluetooth®.

In the following embodiments, “A and/or B” is synonymous with “at least one of A or B.” That is, “A and/or B” means only A, only B, or a combination of A and B. Furthermore, in the present specification, the same concept as “A and/or B” is applied also in a case where three or more things are expressed in a combined manner by “and/or”.

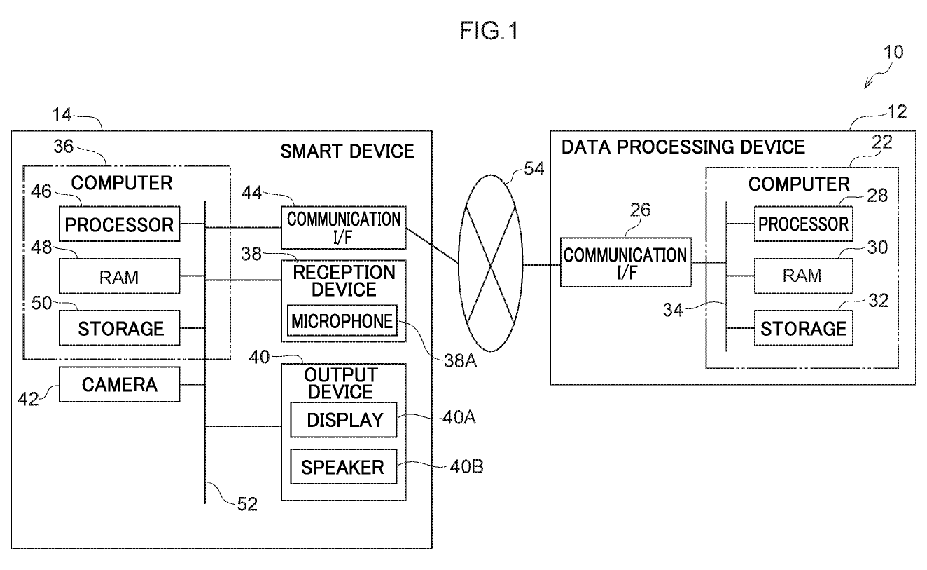

FIG. 1 illustrates an example of a configuration of a data processing system 10 according to an embodiment.

As illustrated in FIG. 1, the data processing system 10 includes a data processing device 12 and a smart device 14. Examples of the data processing device 12 include a server. Examples of the smart device 14 include a smartphone, a tablet terminal, smart glasses, a headset type terminal, a personal computer, and a robot. The smart device 14 is used by a user who is a traveler.

The data processing device 12 includes a computer 22 and a communication I/F 26. The computer 22 is an example of a “computer” according to the technology of the present disclosure. The computer 22 includes a processor 28, a RAM 30, and a storage 32. The processor 28, the RAM 30, and the storage 32 are connected to a bus 34. The communication I/F 26 is also connected to the bus 34. The communication I/F 26 is connected to a network 54. Examples of the network 54 include a wide area network (WAN) and/or a local area network (LAN).

The smart device 14 includes a computer 36, a reception device 38, an output device 40, a camera 42, and a communication I/F 44. The computer 36 includes a processor 46, a RAM 48, and a storage 50. The processor 46, the RAM 48, and the storage 50 are connected to a bus 52. The reception device 38, the output device 40, the camera 42, and the communication I/F 44 are also connected to the bus 52.

The reception device 38 includes a microphone 38A as an example of a voice input device. The reception device 38 receives a user input. The reception device 38 may include a touch panel, a keyboard, a mouse, and the like. The output device 40 includes a display 40A, a speaker 40B, and the like. The output device 40 presents data to the user by outputting the data in a user-perceptible expression (e.g., video, image, voice and/or text). The camera 42 is a small digital camera on which an optical system including a lens, a diaphragm, a shutter, etc. and an imaging element such as a complementary metal-oxide-semiconductor (CMOS) image sensor or a charge coupled device (CCD) image sensor are mounted.

The communication I/F 44 is connected to the network 54. The communication I/Fs 44 and 26 manage exchange of various types of information between the processor 46 and the processor 28 via the network 54.

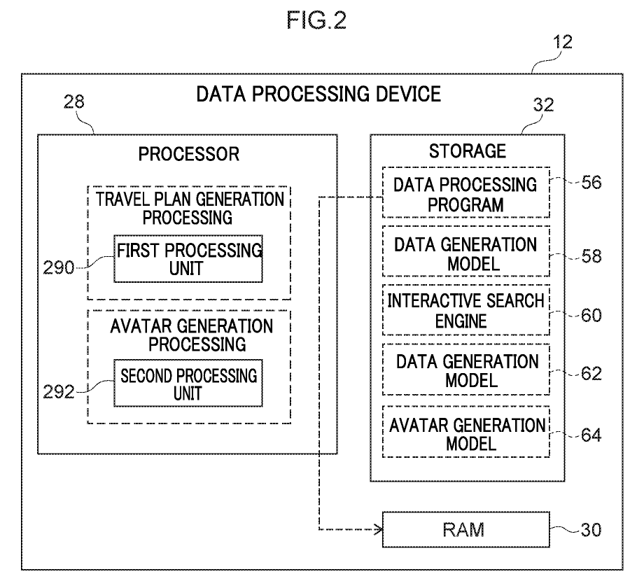

FIG. 2 illustrates an example of functions of main parts of the data processing device 12. As illustrated in FIG. 2, in the data processing device 12, travel plan generation processing and avatar generation processing are performed by the processor 28. The storage 32 stores a data processing program 56. The processor 28 reads the data processing program 56 from the storage 32 and executes the read data processing program 56 on the RAM 30. The travel plan generation processing is realized by the processor 28 operating as a first processing unit 290 according to the data processing program 56 executed on the RAM 30. The avatar generation processing is realized by the processor 28 operating as a second processing unit 292 according to the data processing program 56 executed on the RAM 30.

The storage 32 stores a data generation model 58, an interactive search engine 60, a data generation model 62, and an avatar generation model 64. The data generation model 58 and the interactive search engine 60 are used by the first processing unit 290. The data generation model 62 and the avatar generation model 64 are used by the second processing unit 292. At least one of the data generation model 58, the interactive search engine 60, the data generation model 62, or the avatar generation model 64 may be provided in an external system such as a cloud server accessible via the network 54.

The data generation model 58 is an example of generative artificial intelligence (AI) used for generating a travel plan. Examples of the generative AI include ChatGPT® and Gemini®. The data generation model 58 is obtained by causing a neural network to perform deep learning. A prompt including an instruction is input to the data generation model 58, and inference data such as voice data indicating a voice, text data indicating a text, or image data indicating an image is also input. The data generation model 58 infers the input inference data according to the instruction indicated by the prompt, and outputs an inference result in a data format such as voice data or text data. Here, the inference refers to, for example, analysis, classification, prediction, and/or summary.

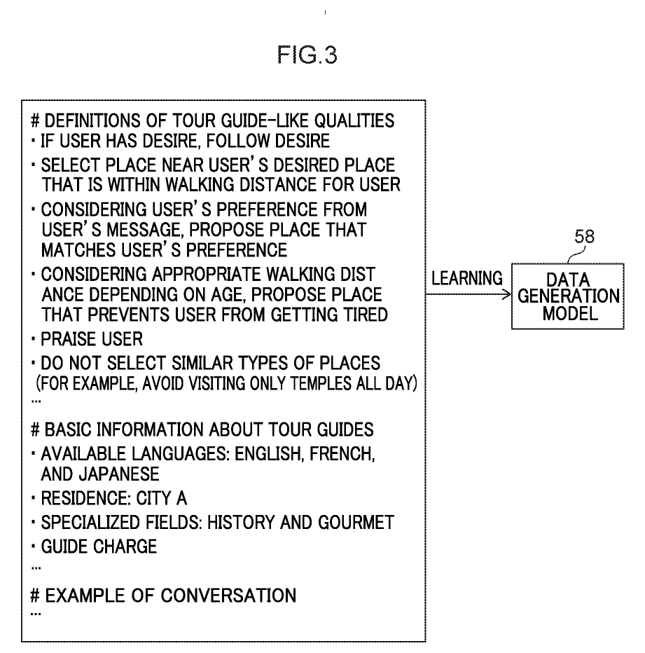

As illustrated in FIG. 3, the data generation model 58 according to the present embodiment is a model trained in advance using information regarding real tour guides’ knowledge. The information regarding tour guides’ knowledge includes knowledge obtained by the tour guides through research, knowledge obtained by the tour guides from past experiences, content that the tour guides actually explained to travelers during past tours, and the like. For example, the information regarding tour guides’ knowledge includes knowledge such as considerations for the user, e.g., what visit destination to propose to the user, the user’s preferences, movement efficiency, and how to develop interaction with the user. In addition, the data generation model 58 is trained in advance using basic information about tour guides such as languages they can handle, specialized fields, and preferences. As a result, the data generation model 58 becomes a model reflecting the features of the tour guides. Note that the data generation model 58 may be further trained in advance using definitions of human-like qualities such as considerations for the user, e.g., what visit destination to propose to the user, the user’s preferences, movement efficiency, and how to develop interaction with the user.

The interactive search engine 60 is AI that responds to an input by performing a search using an existing search engine in an interactive manner.

The data generation model 62 is an example of generative AI used for generating a tour guide’s guidance talk about a user’s visit destination included in a travel plan, and is an example of text generation AI according to the technology of the present disclosure. The data generation model 62 according to the present embodiment is a model trained in advance using information regarding real tour guides’ knowledge. The information regarding tour guides’ knowledge includes knowledge obtained by the tour guides through research, knowledge obtained by the tour guides from past experiences, content that the tour guides actually explained to travelers during past tours, and the like. For example, the information regarding tour guides’ knowledge includes experiences at visit destinations visited by tour guides. Furthermore, for example, the information regarding tour guides’ knowledge includes how to develop interaction and tour guide’s personal opinions. The user’s visit destinations according to the present embodiment include, for example, areas, various facilities, various stores, and the like that the user visits during the travel. Note that the data generation model 62 may be further trained in advance using definitions of human-like qualities such as considerations.

The avatar generation model 64 is an example of avatar generation AI that generates a guide avatar corresponding to a virtual tour guide. After a text is input, the avatar generation model 64 outputs voice data corresponding to the input text and video data of a guide avatar that makes a talking motion in accordance with the voice data. The avatar generation model 64 according to the present embodiment is trained in advance, using video data of real tour guides, to learn external appearance characteristics of the tour guides, motions such as gestures when the tour guides interact. In some embodiments, a human tour guide may interact with the avatar generation model 64 during training. For example, the system can generate an updated training dataset based on outputs of the avatar generation model 64 and labels generated by the human tour guide in response to the outputs. The updated training dataset may also include new external appearance from the human tour guide, new gestures from the human tour guide. In some examples, the system may remove and/or restrict some appearance or gestures from the updated training dataset, e.g. based on some travel plans localized or customized to a specific region. For example, a unique gesture showing an unfriendly manner in a local region may be restricted. Using the updated training dataset, the system may re-train the avatar generation model 64.

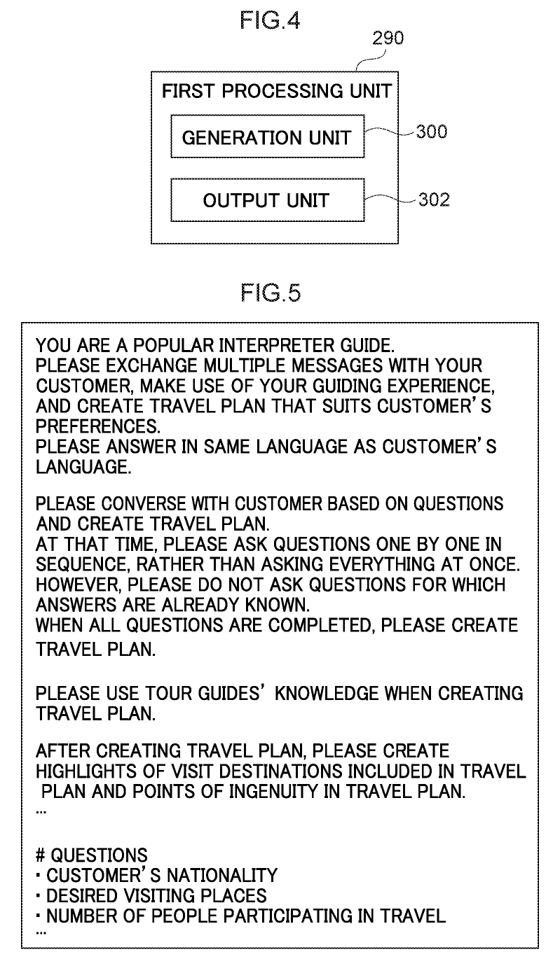

Next, a functional configuration of the first processing unit 290 will be described with reference to FIG. 4. As illustrated in FIG. 4, the first processing unit 290 includes a generation unit 300 and an output unit 302. The generation unit 300 generates a travel plan desired by the user in an interactive manner by controlling interaction with the user.

The generation unit 300 generates a first travel plan based on the information regarding the user and the data generation model 58 trained in advance using the information regarding tour guides’ knowledge. In the present embodiment, the generation unit 300 inputs a prompt including questions for the user into the data generation model 58. FIG. 5 illustrates an example of the prompt. As illustrated in FIG. 5, the prompt input into the data generation model 58 includes questions for the user. As a result, the generation unit 300 causes the data generation model 58 to acquire information regarding the user. Examples of the information regarding the user include nationality, gender, age, the number of participants in the travel, a place that the user wants to visit, a user’s personal interest, a user’s preference, and the like. Based on the prompt, the data generation model 58 may create questions automatically and present them to the user. In some examples, the data generation model 58 can generate and present follow-up questions based on answers provided by the user.

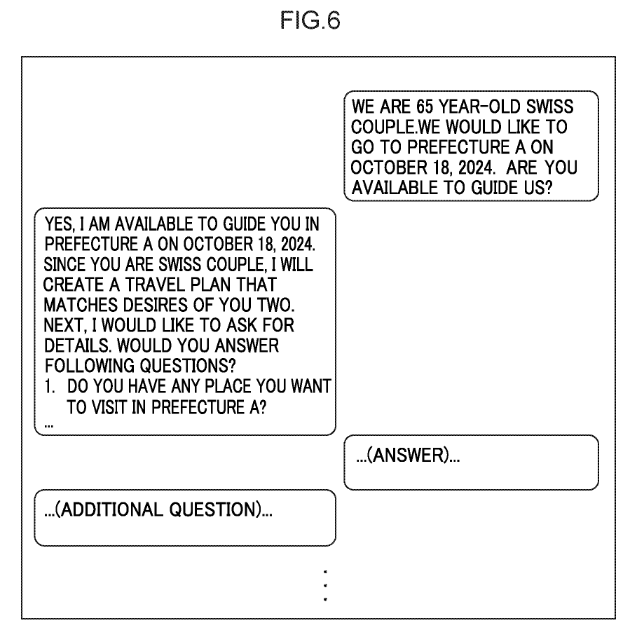

The prompt also includes a text instructing to create a travel plan by exchanging multiple messages with the user and by asking questions one by one in sequence. As a result, as illustrated in FIG. 6 as an example, the generation unit 300 generates a travel plan desired by the user by repeating the interaction with the user using the data generation model 58. In the example of FIG. 6, the right side represents user's input, and the left side represents answers of the data generation model 58. In this interaction, the user performs the input by voice via the microphone 38A. The processor 46 of the smart device 14 converts voice data representing the user input into text data and transmits the text data to the data processing device 12. The generation unit 300 inputs, into the data generation model 58, the text data obtained by converting the voice data representing the user input acquired in the smart device 14. In some embodiments, the data generation model 58 may be re-trained or fine-tuned based on historical travel plans accepted by users.

The prompt also includes a text instructing use of tour guides’ knowledge. As a result, the data generation model 58 generates a travel plan based on the information regarding tour guides’ knowledge learned in advance. In addition, the prompt includes an instruction to generate highlights of visit destinations included in the travel plan generated by the data generation model 58 and a points of ingenuity in the travel plan. In some embodiments, the travel plan may include multiple components including but not limited to: a table, a description, a normal summary, and points of ingenuity.

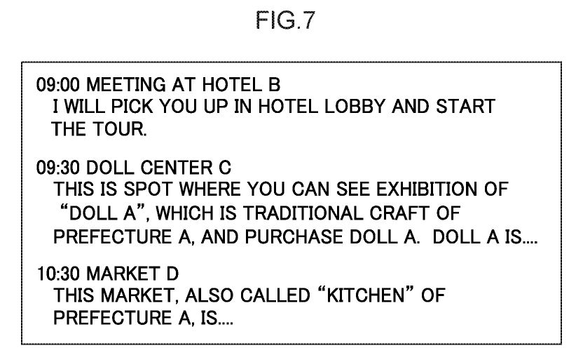

FIG. 7 illustrates an example of the first travel plan. As illustrated in FIG. 7, the first travel plan includes visit destinations at the travel steps and start times of the respective steps. In addition, the first travel plan includes a highlight of each visit destination.

The generation unit 300 generates a second travel plan in which the first travel plan is detailed by inputting the first travel plan generated by the data generation model 58 into the interactive search engine 60. At this time, for example, the generation unit 300 also inputs, into the interactive search engine 60, a text indicating an instruction to add various types of information such as information regarding a means of movement when the user moves from a visit destination at each step included in the first travel plan to a visit destination at the next step, a usage fee of the means of movement, a required time for movement, and a usage fee of each visit destination. As a result, a second travel plan in which the first travel plan is detailed is generated by adding information to the first travel plan. In some examples, based on a user request or pre-configuration, the data generation model 58 may automatically cooperate with the interactive search engine 60 to directly generate the second travel plan, without generating the first travel plan.

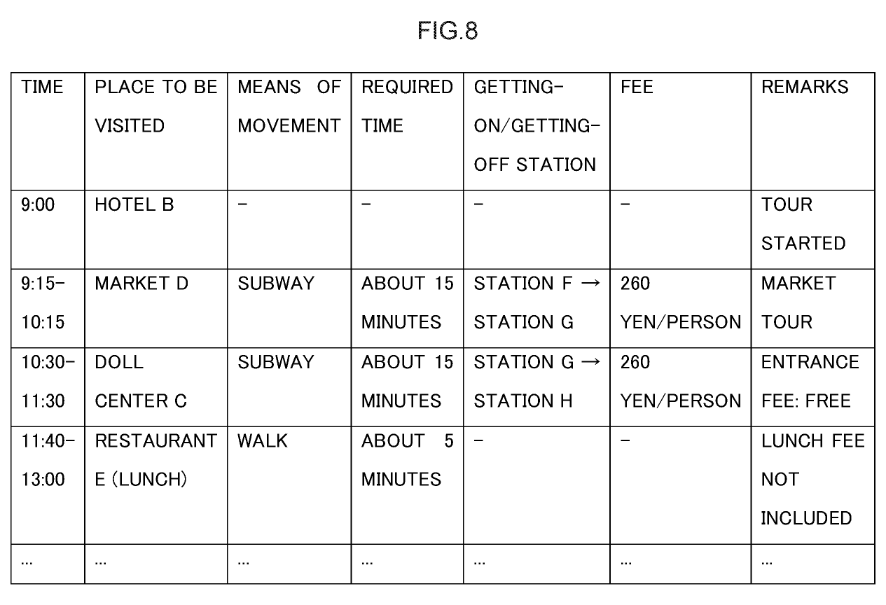

FIG. 8 illustrates an example of the second travel plan. As illustrated in FIG. 8, the second travel plan includes an arrival time and a departure time at each step of the travel, a visit destination, a means of movement between visit destinations, a time required for movement, a getting-on station and a getting-off station in a case where the means of movement is a train, a usage fee of the means of movement, and remarks. The remarks include additional information such as a usage fee of a visit destination at each stage.

The second travel plan is generated using the interactive search engine 60. Therefore, the latest information published on the web may be retrieved by the search engine, and as a result, an appropriate travel plan may be generated. That is, by using the interactive search engine 60, which is search-based generative AI, the data processing system 10 according to the present embodiment may dynamically acquire and analyze the latest tourism information, reviews, regional information, and the like on the Internet and reflect them in the travel plan.

Note that the generation unit 300 may generate, as information regarding the second travel plan, a link for obtaining information about a visit destination of the user included in the second travel plan. For example, the generation unit 300 may generate a hypertext transfer protocol (HTTP) link to an official website of each visit destination of the second travel plan, a website of a specific service (e.g., gourmet website), or the like.

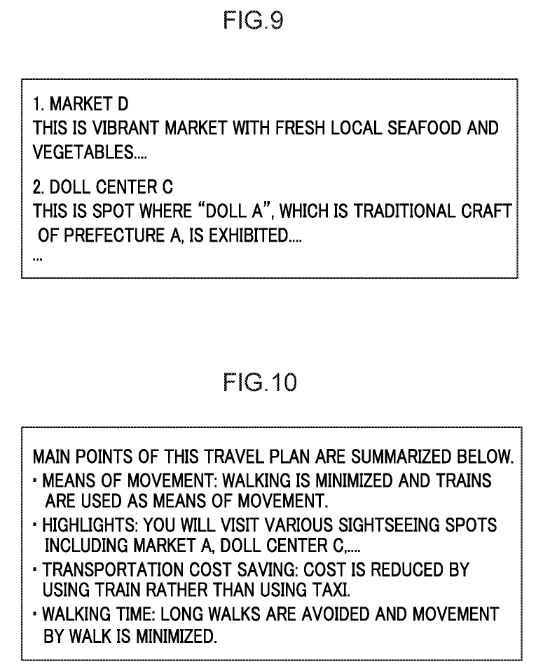

The output unit 302 outputs the information regarding the second travel plan generated by the generation unit 300 to the smart device 14. In the present embodiment, the output unit 302 outputs, to the smart device 14, the second travel plan, highlights of the visit destinations included in the second travel plan, and points of ingenuity in the second travel plan as the information regarding the second travel plan. The information regarding the second travel plan is displayed on the display 40A of the smart device 14. FIG. 9 illustrates an example of a highlight of a visit destination included in the second travel plan, and FIG. 10 illustrates an example of points of ingenuity in the second travel plan. As illustrated in FIG. 10, in the second travel plan, for example, it is considered to reduce movement by walk in consideration of the age of the user and the like. In some embodiments, the travel plan may be generated based on implicit user considerations without a need to ask the user explicitly, e.g. based on previous user behaviors, user interactions, user clicks, etc. According to the present embodiment, it is possible to show considerations for the user in the travel plan, and it is possible to improve the user’s satisfaction.

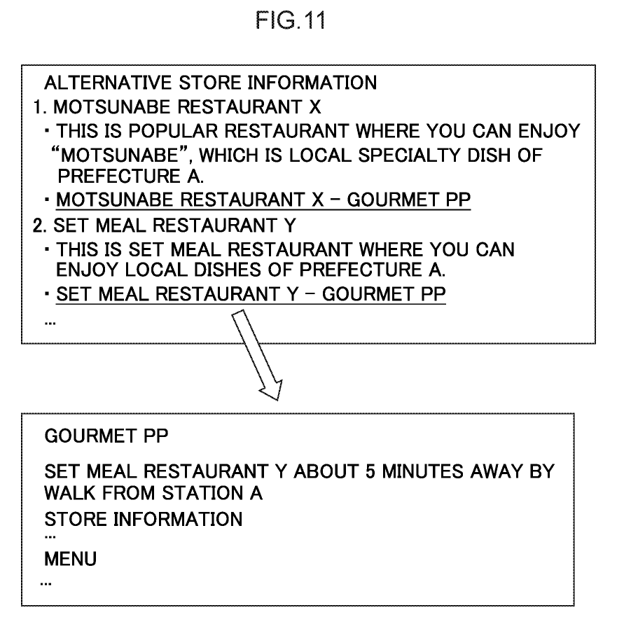

Note that, as illustrated in FIG. 11, the generation unit 300 may generate information regarding a visit destination to substitute for the visit destination included in the second travel plan. FIG. 11 illustrates an example of information on an alternative store in a case where the visit destination is a restaurant. In this case, the generation unit 300 may generate a link for obtaining information on the alternative store. FIG. 11 illustrates an example in which an HTTP link to a specific service that provides information on the alternative store is generated.

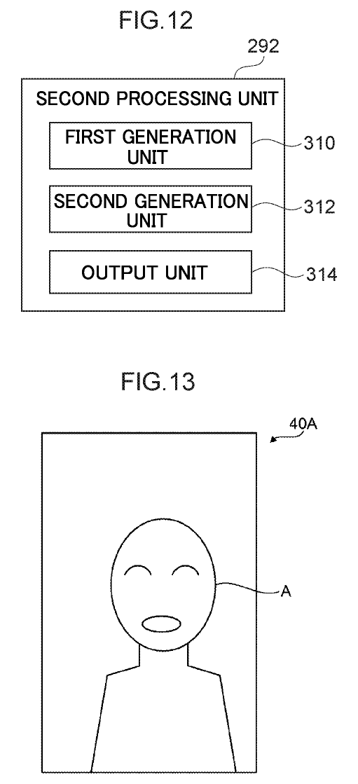

Next, a functional configuration of the second processing unit 292 will be described with reference to FIG. 12. As illustrated in FIG. 12, the second processing unit 292 includes a first generation unit 310, a second generation unit 312, and an output unit 314.

The first generation unit 310 generates a text regarding a visit destination of the user included in the travel plan based on the travel plan generated in advance and the data generation model 62 trained in advance using the information regarding tour guides’ knowledge. In the present embodiment, the first generation unit 310 inputs, into the data generation model 62, information about each visit destination included in the second travel plan generated by the first processing unit 290. The data generation model 62 outputs a text corresponding to a tour guide’s guidance talk about each visit destination input thereto.

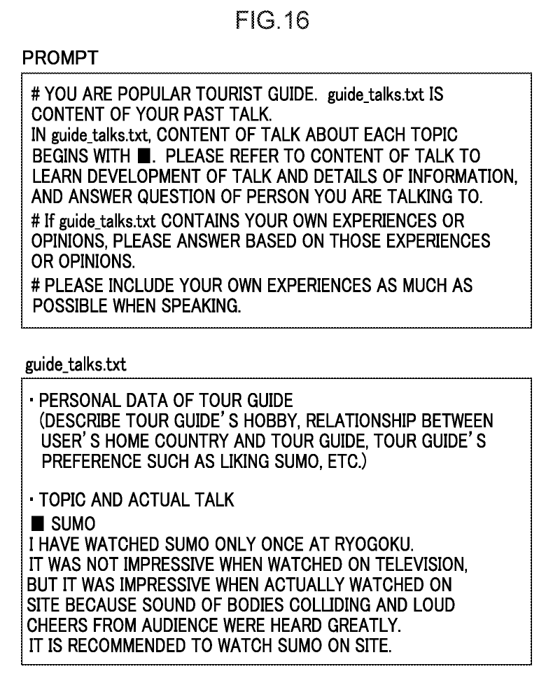

In addition, using the data generation model 62, the first generation unit 310 generates a text corresponding to a talk in which the user may enjoy personal interaction, in addition to the guidance to the sightseeing spot. For example, the first generation unit 310 inputs a prompt illustrated in FIG. 16 into the data generation model 62. FIG. 16 illustrates an example of a prompt and an example of text data regarding tour guides’ knowledge referred to in the prompt. As illustrated in FIG. 16, the prompt includes a text instructing interaction with the user with reference to the contents of past talks that the tour guide had with travelers during actual tours. Furthermore, the text data regarding tour guides’ knowledge includes personal data of the tour guide, topics, and the contents of past talks that the tour guide had with travelers during actual tours regarding the topics. For example, the contents of the talks may be input by the tour guide by inputting texts, or may be input by converting voices uttered by the tour guide into texts.

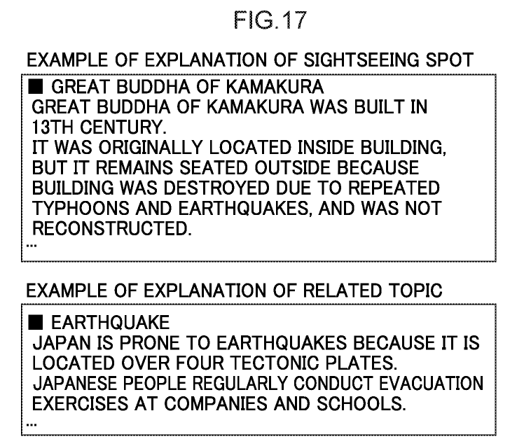

As illustrated in FIG. 17 as an example, by using the trained data generation model 62, the first generation unit 310 may generate a text for performing interaction regarding a topic or the like related to the sightseeing spot in addition to the explanation of the sightseeing spot.

In this interaction, the user performs the input by voice via the microphone 38A. The processor 46 of the smart device 14 converts voice data representing the user input into text data and transmits the text data to the data processing device 12. The first generation unit 310 inputs the text data obtained by converting the voice data representing the user input acquired in the smart device 14 into the data generation model 62.

The second generation unit 312 generates a guide avatar based on the text generated by the first generation unit 310 and the avatar generation model 64. In the present embodiment, the second generation unit 312 inputs the text generated by the first generation unit 310 into the avatar generation model 64. The avatar generation model 64 outputs voice data corresponding to the input text and video data of the guide avatar that moves its mouth and makes gestures to speak the text. In some embodiments, upon agreement from a user, the avatar generation model 64 may work in concert with a location device to collect real-time location information of the user and proactively remind the user about the next direction or path to go based on the travel pan.

The output unit 314 outputs data corresponding to the text generated by the second generation unit 312. In the present embodiment, the output unit 314 outputs the voice data corresponding to the text generated by the second generation unit 312 and the video data of the guide avatar to the smart device 14. As illustrated in FIG. 13 as an example, a video of guide avatar A that talks about a visit destination of the user is displayed as a virtual tour guide on the display 40A of the smart device 14. Furthermore, the voice of the guide avatar is output from the speaker 40B of the smart device 14.

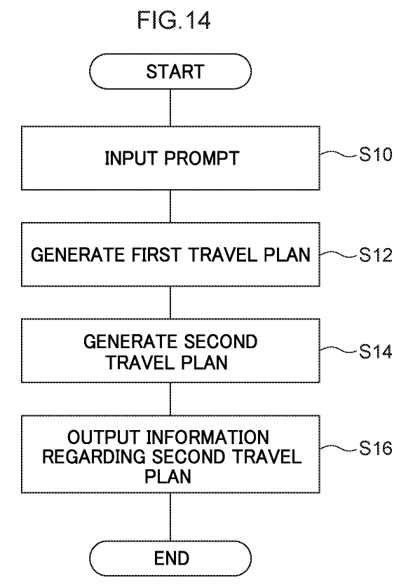

Next, an example of a flow of travel plan generation processing will be described with reference to FIG. 14.

In step S10, the generation unit 300 inputs a prompt including questions for the user into the data generation model 58. In step S12, as described above, the generation unit 300 generates a first travel plan based on the information regarding the user and the data generation model 58. In step S14, the generation unit 300 generates a second travel plan in which the first travel plan is detailed by inputting the first travel plan generated in step S12 into the interactive search engine 60.

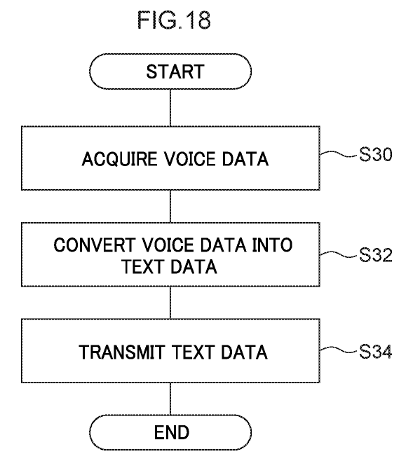

In step S16, the output unit 302 outputs the information regarding the second travel plan generated in step S14 to the smart device 14. After the processing of step S16 ends, the travel plan generation processing ends. For example, the user may input a request with respect to the presented second travel plan via the reception device 38. In this case, steps S12 and S14 are executed again, and a second travel plan corrected based on the request is generated. In this manner, by generating a travel plan while interacting with the user using the generative AI, it is possible to provide a travel plan with a high degree of freedom suitable for the user. Furthermore, in this interaction, the smart device 14 performs voice input processing illustrated in FIG. 18 as an example. In some examples, the travel plan may serve as an instruction signal to trigger an automatic display of a promotion on the smart device 14, e.g. when a discount deal at one destination of the travel plan is ending soon. In some examples, the output unit 302 may automatically send a corrected travel plan which can trigger the smart device 14 to ring and/or vibrate, e.g. if there is any unexpected event like earthquake, hurricane, etc., at one destination of the travel plan. In some examples, the smart device 14 may be associated with a self-driving vehicle, such that the travel plan can serve as an instruction signal to directly trigger a movement of the self-driving vehicle to go to a destination or follow a route based on the travel plan and factors including travel cost, interest, weather, etc.

The user performs input by voice via the microphone 38A. In step S30 of FIG. 18, the processor 46 of the smart device 14 acquires voice data representing a user input. In step S32, the processor 46 converts the voice data acquired in step S30 into text data using a voice recognition technology. In step S34, the processor 46 transmits the text data obtained by the processing in step S32 to the data processing device 12.

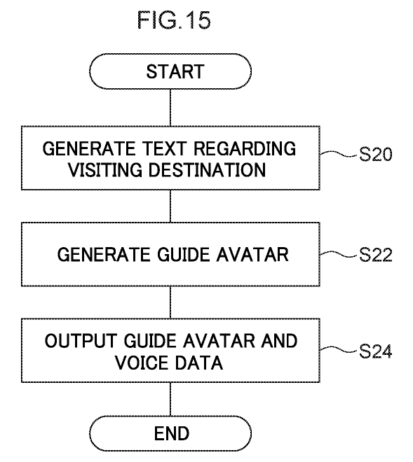

Next, an example of a flow of avatar generation processing will be described with reference to FIG. 15. For example, after the user designates a visit destination from the second travel plan, the second processing unit 292 executes avatar generation processing for the designated visit destination. Note that, when the user takes a photo at a visit destination and inputs a guide start instruction, the second processing unit 292 may identify the visit destination of the user from the photo. In this case, the second processing unit 292 executes avatar generation processing for the identified visit destination. In some examples, the avatar generation processing may take into consideration local culture, habits, rules, laws, etc. of the identified visit destination, when generating the guide avatar.

In step S20, the first generation unit 310 generates a text regarding a visit destination of the user included in the second travel plan based on the second travel plan and the data generation model 62. In step S22, the second generation unit 312 generates a guide avatar based on the text generated in step S20 and the avatar generation model 64.

In step S24, the output unit 314 outputs the voice data generated in step S22 and the video data of the guide avatar to the smart device 14. After the processing of step S24 ends, the avatar generation processing ends. In this manner, the guide avatar, which is a virtual tour guide, talks about a visit destination of the user, whereby the shortage of tour guides may be resolved. In this interaction with the guide avatar as well, the user performs the input by voice via the microphone 38A, and the voice input processing illustrated in FIG. 18 is performed.

As described above, according to the present embodiment, the user may interact with the guide avatar using the voice input function of the smart device 14. The user utterance is converted into a text by the voice recognition technology, and the text is input into the data generation model 62. As a result, a more natural and intuitive user interface is realized, enabling the user to use a tour guide through a guide avatar in a hands-free manner. In some examples, the guide avatar may perform proactively, e.g. based on user location, user dwell time in front of a famous drawing, a famous place, etc., without waiting for user request. For example, the guide avatar may start explaining a history of a mountain when the user is near or under the mountain, without waiting for any request or questions from the user.

In the above-described embodiment, the data processing system 10 may have a matching function of presenting a recommended guide avatar to the user. For example, the processor 28 of the data processing device 12 selects a set of a data generation model 62 and an avatar generation model 64 optimal for the user from among plural sets of data generation models 62 and avatar generation models 64 based on the user’s interests and preferences. The processor 28 may use the basic information about tour guides illustrated in FIG. 3 for this selection. The user may select a guide avatar to use from among the recommended guide avatars. As a result, a more personalized travel experience can be realized for the user.

In the above-described embodiment, the processor 28 of the data processing device 12 may use output data of various sensors mounted on the smart device 14, such as a global positioning system (GPS) device, an acceleration sensor, and a gyro sensor. By using the output data of the various sensors, it is possible to provide real-time guidance based on the user’s positions, movements, etc.

Although the system according to the present disclosure has been described above mainly in terms of the functions of the data processing device 12, the system according to the present disclosure is not necessarily implemented on a server. The system according to the present disclosure may be implemented as a general information processing system. The present disclosure may be implemented as, for example, a software program operating on a personal computer or an application operating on a smartphone or the like. The method according to the present disclosure may be provided to a user in a software as a service (SaaS) format.

In the above-described embodiment, the travel plan generation processing and the avatar generation processing are performed by one computer 22; however, the technology of the present disclosure is not limited thereto. The travel plan generation processing and the avatar generation processing may be performed by plural computers including the computer 22 in a distributed manner. Furthermore, the travel plan generation processing and the avatar generation processing may be executed by different computers.

In the above-described embodiment, the data processing program 56 is stored in the storage 32; however, the technology of the present disclosure is not limited thereto. For example, the data processing program 56 may be stored in a portable computer-readable non-transitory storage medium such as a universal serial bus (USB) memory. The data processing program 56 stored in the non-transitory storage medium is installed in the computer 22 of the data processing device 12. The processor 28 executes travel plan generation processing and avatar generation processing according to the data processing program 56.

In addition, the data processing program 56 may be stored in a storage device such as a server connected to the data processing device 12 via the network 54, and the data processing program 56 may be downloaded and installed in the computer 22 in response to a request from the data processing device 12.

In addition, it is not necessary to store all of the data processing program 56 in a storage device such as a server connected to the data processing device 12 via the network 54 or to store all of the data processing program 56 in the storage 32, and a part of the data processing program 56 may be stored.

The data processing program 56 may be provided as a program product. The program product includes any type of product for providing a program. Examples of the program product includes a program provided through a network such as the Internet and a non-transitory computer-readable recording medium such as a CD-ROM or a DVD storing the program.

The following various processors may be used as hardware resources that execute the specific processing. Examples of the processors include a CPU, which is a general-purpose processor functioning as a hardware resource that executes the specific processing by executing software, that is, a program. In addition, examples of the processors include a dedicated electric circuit, which is a processor having a circuit configuration exclusively designed for executing the specific processing, such as a field-programmable gate array (FPGA), a programmable logic device (PLD), or an application specific integrated circuit (ASIC). A memory is built in or connected to any processor, and any processor executes specific processing by using the memory.

The hardware resource that executes the specific processing may be configured by one of these various processors, or may be configured by a combination of two or more processors of the same type or different types (e.g., a combination of a plurality of FPGAs or a combination of a CPU and an FPGA). The hardware resource that executes the specific processing may be one processor.

As an example in which the hardware resource that executes the specific processing is configured by one processor, first, there is a mode in which one processor is configured by a combination of one or more CPUs and software, and this processor functions as a hardware resource that executes specific processing. Second, as represented by a system-on-a-chip (SoC) or the like, there is a mode in which a processor that realizes the functions of the entire system including plural hardware resources that execute the specific processing on one IC chip is used. In this manner, the specific processing is realized by using one or more of the above-described various processors as hardware resources.

Furthermore, more specifically, an electric circuit in which circuit elements such as semiconductor elements are combined may be used as a hardware structure for these various processors. In addition, the above-described specific processing is merely an example. Therefore, it is needless to say that unnecessary steps may be deleted, new steps may be added, or the processing order may be changed without departing from the gist.

The above-described and illustrated contents are detailed descriptions of parts according to the technology of the present disclosure, and are merely examples of the technology of the present disclosure. For example, the above descriptions regarding configurations, functions, operations, and effects are descriptions regarding examples of configurations, functions, operations, and effects of parts according to the technology of the present disclosure. Therefore, it is needless to say that unnecessary parts may be deleted, new parts may be added, or some parts may be replaced with respect to the above-described and illustrated contents without departing from the gist of the technology of the present disclosure. Furthermore, in order to avoid complication and to facilitate understanding of parts according to the technology of the present disclosure, in the above-described and illustrated contents, descriptions regarding common technical knowledge and the like that do not require any particular description to enable the implementation of the technology of the present disclosure are omitted.

All the documents, patent applications, and technical standards described in the present specification are incorporated herein by reference to the same extent as if each document, patent application, and technical standard were specifically and individually indicated to be incorporated by reference.

With regard to the above-described embodiments, the following supplementary notes are further disclosed.

### Supplementary Note 1

A data processing device including:

a generation unit configured to generate a travel plan based on information regarding a user and generative AI trained in advance using information regarding tour guides’ knowledge; and

an output unit configured to output information regarding the travel plan.

### Supplementary Note 2

The data processing device according to supplementary note 1, wherein

the generation unit causes the generative AI to acquire the information regarding the user by inputting a prompt including questions for the user into the generative AI.

### Supplementary Note 3

The data processing device according to supplementary note 2, wherein

the prompt further includes an instruction to generate a highlight of a visit destination included in the travel plan and a points of ingenuity in the travel plan, and

the output unit outputs the travel plan, the highlight of the visit destination, and the points of ingenuity in the travel plan as the information regarding the travel plan.

### Supplementary Note 4

The data processing device according to any one of supplementary notes 1 to 3, wherein

by inputting a first travel plan generated by the generative AI into an interactive search engine, the generation unit generates a second travel plan in which the first travel plan is detailed, and

the output unit outputs information regarding the second travel plan.

### Supplementary Note 5

The data processing device according to any one of supplementary notes 1 to 4, wherein

the generation unit generates a link for obtaining information about a visit destination of the user included in the travel plan as the information regarding the travel plan.

### Supplementary Note 6

The data processing device according to any one of supplementary notes 1 to 5, wherein

the generative AI is trained in advance further using definitions of human-like qualities.

### Supplementary Note 7

The data processing device according to any one of supplementary notes 1 to 6, wherein

the generation unit inputs text data obtained by converting voice data representing a user input acquired in a smart device into the generative AI.

### Supplementary Note 8

A data processing method executed by a computer, the data processing method including:

generating a travel plan based on information regarding a user and generative AI trained in advance using information regarding tour guides’ knowledge; and

outputting information regarding the travel plan.

### Supplementary Note 9

A data processing program for causing a computer to execute:

generating a travel plan based on information regarding a user and generative AI trained in advance using information regarding tour guides’ knowledge; and

outputting information regarding the travel plan.

What is claimed is:

1. A data processing device, comprising:
a memory; and
a processor that is configured to:
generate a text related to a user's visit destination included in a travel plan generated in advance, generation of the text being based on the travel plan and text generation AI trained in advance using information regarding tour guides’ knowledge; and
output data according to the text.

2. The data processing device according to claim 1, wherein the processor is further configured to:
generate a guide avatar based on the text and an avatar generation AI; and
output audio data corresponding to the text and video data corresponding to the guide avatar.

3. The data processing device according to claim 2, wherein the avatar generation AI is trained in advance by using video data of the tour guides to learn external appearance characteristics of the tour guides and motions when the tour guides interact.

4. The data processing device according to claim 1, wherein the text generation AI is trained in advance by using definitions of human-like qualities.

5. The data processing device according to claim 1, wherein the processor is further configured to:
input, into the text generation AI, text data obtained by converting audio data representing a user input received at a smart device.

6. A data processing method executed by a computer, the data processing method comprising:
generating a text related to a user's visit destination included in a travel plan generated in advance, generation of the text being based on the travel plan and text generation AI trained in advance using information regarding tour guides’ knowledge; and
outputting data according to the text.

7. A non-transitory computer-readable storage medium storing instructions that, when executed by a computer, causes the computer to:
generate a text related to a user's visit destination included in a travel plan generated in advance, generation of the text being based on the travel plan and text generation AI trained in advance using information regarding tour guides’ knowledge; and
output data according to the text.
